(19) United States
(12) Patent Application Publication
(10) Pub. No.: US 2022/0347956 A1
(43) Pub. Date: Nov. 3, 2022

(54) PRESSURIZATION DEVICE

(71) Applicant: TOMY COMPANY, LTD., TOKYO (JP)

(72) Inventors: Keita ICHIKAWA, TOKYO (JP); Kuniharu HIRABAYASHI, TOKYO (JP)

(73) Assignee: TOMY COMPANY, LTD., TOKYO (JP)

(21) Appl. No.: 17/463,273

(22) Filed: Aug. 31, 2021

(30) Foreign Application Priority Data
Apr. 30, 2021 (JP) 2021-077444

(51) Int. Cl. B30B 1/00; A44C 3/00; A44C 27/00; B30B 9/28

(52) U.S. Cl. CPC B30B 1/00; A44C 3/001; A44C 27/00; B30B 9/28

(57) ABSTRACT

A pressurization device includes a body, a shaft, and a stopper. The body includes a setting section and an insertion section. The setting section is configured to accommodate an object to be pressurized. The insertion section includes a female thread part formed on a hole wall thereof. The shaft has a male thread part. The shaft is configured to advance and retreat with respect to the setting section by rotation. The stopper is configured on the shaft. The pressing part is configured on a first longitudinal end of the shaft to press the object in the setting section against a prescribed fixed part when the shaft advances. The handle is configured on a second longitudinal end of the shaft to rotate the shaft. The handle includes a torque limiter being configured to block transmission of power between the handle and the shaft when the power exceeds a prescribed amount.

### CROSS-REFERENCE TO THE RELATED APPLICATION

This application claims priority to Japanese Patent Application No. 2021-077444 filed on Apr. 30, 2021. The entire content of Japanese Patent Application No. 2021-077444 is incorporated herein by reference.

### BACKGROUND

### Technical Field

The present invention relates to a pressurization device.

### Background Art

Conventionally, as a pressurization device, the item noted in Patent Document 1 incorporated in a badge manufacturing device is known. This pressurization device is for manufacturing a badge having a front cover and a back cover, and with the front cover and the back cover overlapped and set in a setting section inside a body, by operating a handle, a manufacturing unit (pressing part) is made to enter the setting part using a screw mechanism, and front cover processing is done by pressure-engaging with the front cover. With this kind of pressurization device, a torque limiter is provided inside the handle, and when excess load is applied, power transmission is blocked so as not to transmit the power of the handle to the manufacturing unit.
Patent Document 1: Japanese Patent No. 3586459

### SUMMARY

### Problems the Invention is Intended to Solve

However, with this kind of pressurization device, when there is an object to be pressurized, if the manufacturing unit presses more than necessary on the object to be pressurized, the torque limiter operates, and the handle spins idly, thus preventing the object to be pressurized from being crushed more than necessary.

However, if there is no object to be pressurized in the setting section inside the body, when the handle is turned accidentally and the manufacturing unit is lowered, the handle contacts the body top surface and has forceful sliding contact, so there was the risk of damage to the handle or the body.

The present invention was created considering these points, and its purpose is to provide a pressurization device that can prevent sliding contact between the handle and the body outer surface.

### Means for Solving the Problems

A pressurization device includes a body, a shaft, and a stopper.

The body includes a setting section and an insertion section. The setting section is configured to accommodate an object to be pressurized. The insertion section includes a female thread part formed on a hole wall thereof.

The shaft has a first longitudinal end and a second longitudinal end being opposite to the first longitudinal end. The first longitudinal end is inserted in the setting section. The second longitudinal end is at outside of the body. The shaft has a male thread part being engaged with the female thread part. The shaft is configured to advance and retreat with respect to the setting section by rotation with a central axis as the center.

The stopper is configured on the shaft.

The pressing part is configured on the first longitudinal end to press the object in the setting section against a prescribed fixed part when the shaft advances.

The handle is configured on the second longitudinal end to rotate the shaft. The handle includes a torque limiter being configured to block transmission of power between the handle and the shaft when the power exceeds a prescribed amount.

When the female thread part is engaged with the male thread part and when the shaft enters deeper than a prescribed position, the stopper is configured to abut an outer surface of the body and to block the handle from abutting the outer surface of the body.

### BRIEF DESCRIPTION OF THE DRAWINGS

FIG. 1 is a perspective view of a molding device that comprises a pressurization device of an embodiment.

FIG. 2 is a perspective view showing the state with the molding die of the molding device opened.

FIG. 3 is a perspective view of the top die seen from below.

FIG. 4 is a front view showing the internal state of the pressurization device.

FIG. 5 is a front view showing the internal state when the object to be pressurized of the pressurization device is pressed.

FIG. 6 is a front view showing the internal state when a shaft of the pressurization device rises.

FIG. 7 is a front view showing the internal state when the shaft of the pressurization device is lowered excessively.

FIG. 8 is a plan view showing the handle interior of the pressurization device.

FIG. 9 is a perspective view of the pressurization device showing the attachment structure of the shaft.

FIG. 10 is a perspective view showing an example of using an egg-shaped container manufactured by the molding device.

### DETAILED DESCRIPTION OF THE PREFERRED EMBODIMENTS

Hereafter, a mode for carrying out the invention is explained while referring to the attached drawings.

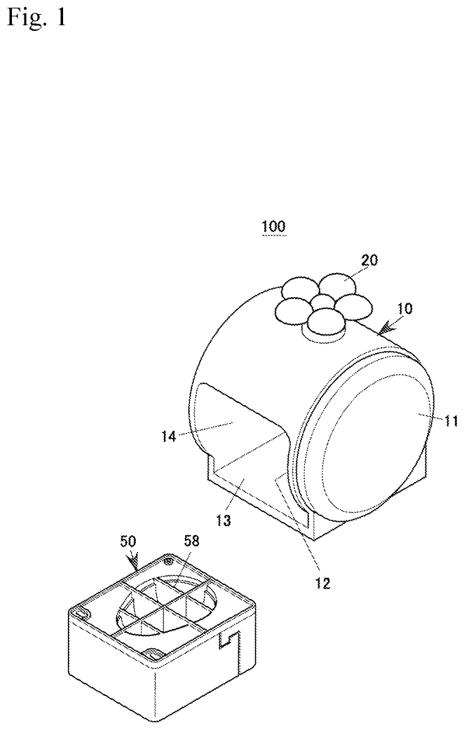

FIG. 1 is a perspective view of a molding device 100 of an embodiment that comprises a pressurization device 10 and a molding die 50. Using this molding device 100, it is possible to create an egg-shaped container 80 like that shown in FIG. 10.

### Molding Die 50

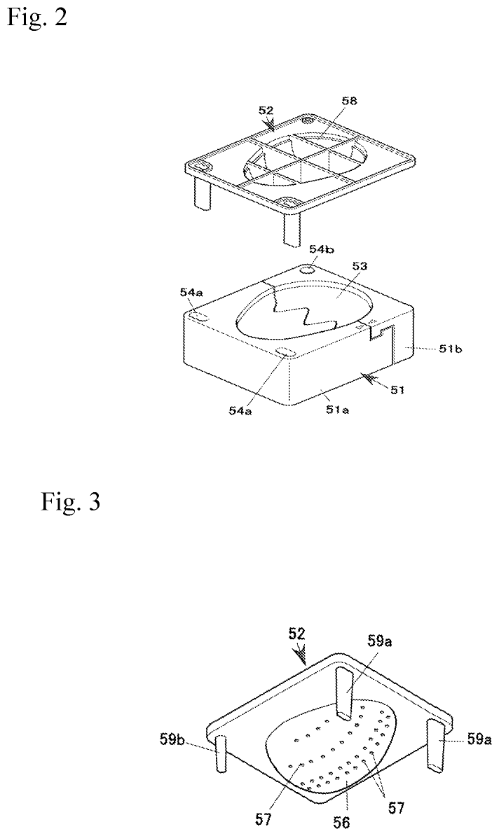

FIG. 2 is a perspective view showing the state with the molding die 50 open.

The molding die 50 is for molding a molding material. As molding material, paper such as toilet paper that is easy to mold when water is included is used, for example. Instead of paper, it is also possible to use paper clay or clay.

In specific terms, the molding die 50 of the embodiment is for creating a container half body 81 of the egg-shaped body 80 (see FIG. 10), and as shown in FIG. 2, is constituted by a cuboid lower die 51, and a rectangular plate-shaped upper die 52 that is placed on the lower die 51. Though not particularly limited, the lower die 51 and the upper die 52 are made of plastic.

A half egg-shaped hole (recess) 53 is formed on the top surface of the lower die 51. One oval-shaped hole 54a each is formed on two corner parts of one short side part of this lower die 51. Also, a circular hole 54b is formed on one corner part of the other short side part of the lower die 51. This lower die 51 is constituted from two parts 51a, 51b aligned in the long side direction, and the two parts 51a, 51b can be separated by a center part in the longitudinal direction of the hole 53. Also, with the lower die 51, the part 51b is detachable from above with respect to the part 51a, so it is easy to separate the molded article, and easy to do cleaning.

FIG. 3 is a perspective view of the upper die 52 seen from below.

On the upper die 52 is formed a bulging part 56 of a prescribed thickness, that has a complementary shape with the hole 53 of the lower die 51, and that is fitted in that hole 53 with a prescribed gap. A large number of drain holes 57 are formed on the bulging part 56. Also, as shown in FIG. 1 and FIG. 2, the back side of the bulging part 56 has a complementary shape to the bulging part 56, and a reinforcing plate 58 is provided in a lattice form here. Furthermore, on the upper die 52, two tapered projections 59a corresponding to the two oval-shaped holes 54a of the lower die 51, and a tapered projection 59b corresponding to the circular hole 54b are formed. Also, by fitting the two projections 59a of the upper die 52 in the two holes 54a of the lower die 51, and the projection 59b of the upper die 52 in the hole 54b of the lower die 51, the upper die 52 is aligned with respect to the lower die 51. This makes it possible to create a molded article of a prescribed thickness.

### Pressurization Device 10

As shown in FIG. 1, the pressurization device 10 comprises a body 11 in the shape of a sideways laying cylinder, for which the bottom surface is flat. A rectangular opening 12 is formed on the front surface of the body 11 when viewed from the front, and in the back of this opening 12, a setting section 14 having a floor 13 on which the molding die 50 is set is formed.

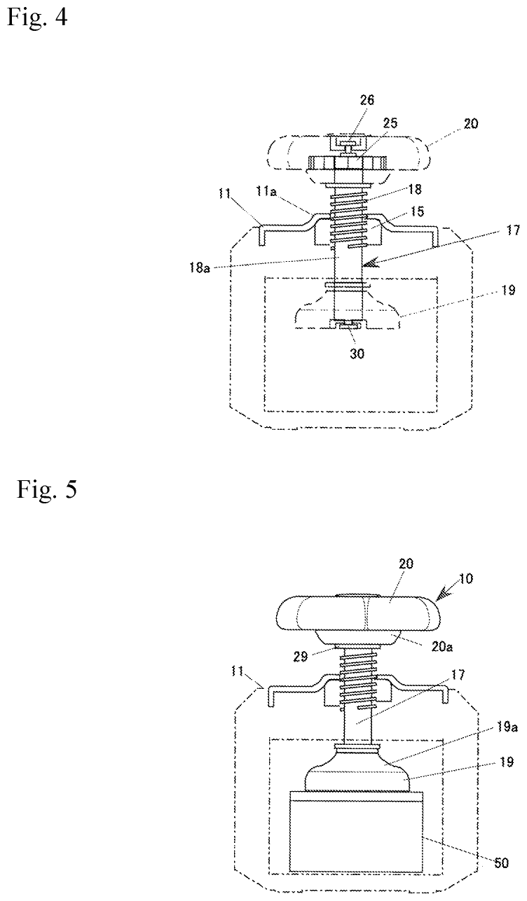

FIG. 4 is a front view showing the internal state of the pressurization toy 10.

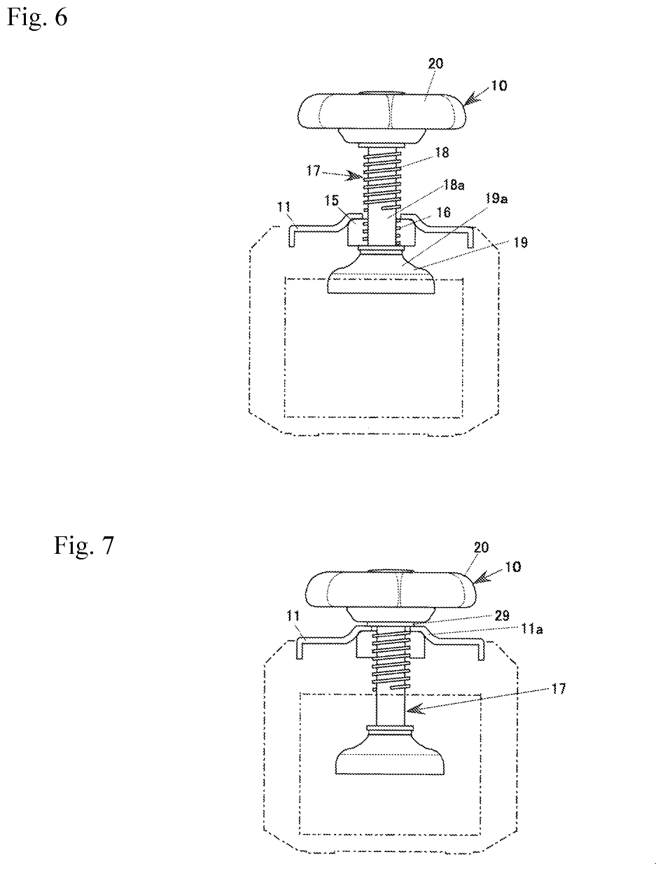

As shown in the drawing, a screw cylinder (insertion section) 15 having a central axis line extending in the vertical direction is provided on the ceiling part of the setting section 14 in the body 11, and a female thread part 16 (see FIG. 6) is formed in the hole wall of this screw cylinder 15. Though not particularly limited, the screw cylinder 15 is made of plastic.

Also, inserted in the screw cylinder 15 is a shaft 17 that, though not particularly limited, is made of plastic. A male thread part 18 is partially formed on the shaft 17, and the male thread part 18 is screwed into the female thread part 16. On the bottom end part of the shaft 17, as shown in FIG. 5, a pressing part 19 is attached to be able to spin idly with the central axis line of the shaft 17 as the center. Specifically, the top surface of the pressing part 19 is raised in a mountain shape, and the bottom end part of the shaft 17 is inserted in the hole (not illustrated) formed on the top of a raised part 19a thereof. Then, attachment of the pressing part 19 to the shaft 17, though not particularly limited, is performed using a tapping screw 30 (see FIG. 4). Also, the top end part of the shaft 17 protrudes above the body 11, and as shown in FIG. 4, faces the inside of the handle 20. The top surface (outer surface) of the body 11 is a raised part 11a in which the peripheral part of the shaft 17 is raised. As a result, when a stopper 29 described later contacts the outer surface of the body 11 due to this raised part 11a, a gap is created between the outer periphery part of the handle 20 and the outer surface of the body 11.

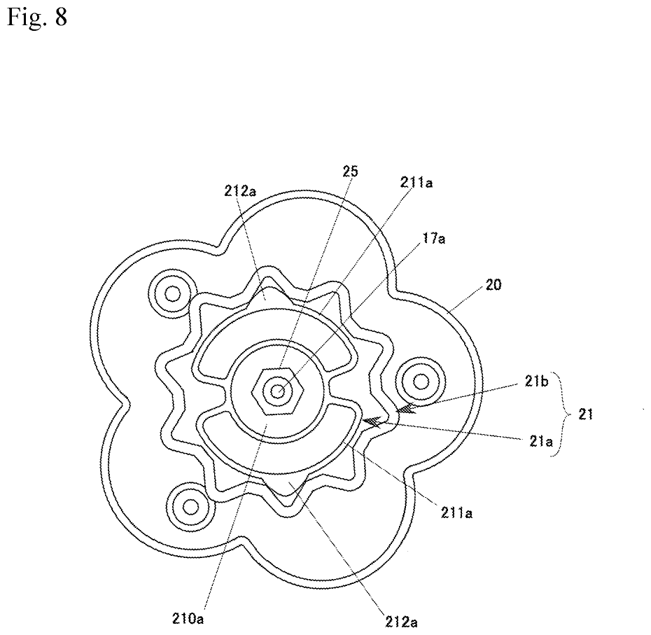

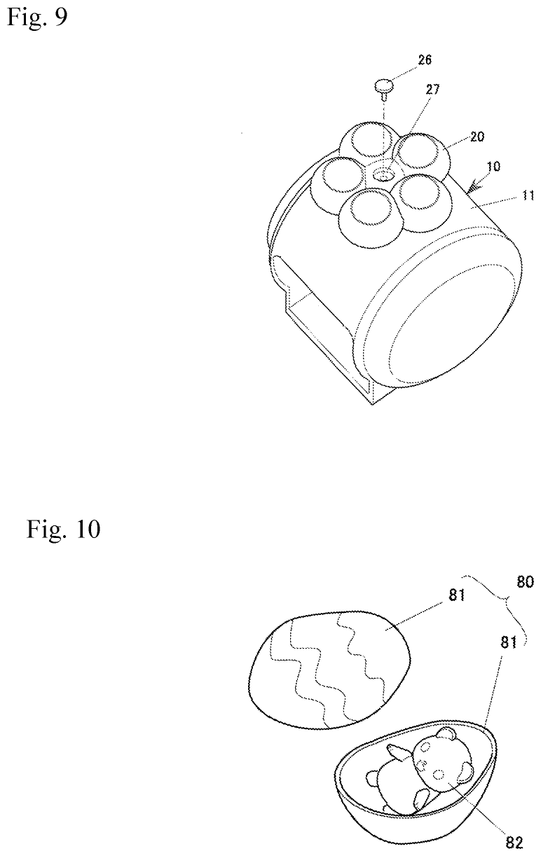

The top end part of the shaft 17 facing the inside of the handle 20 has a small diameter, a male thread part (not illustrated) is formed on that small diameter part, and a nut 25 (see FIG. 4 and FIG. 8) is screwed into this male thread part. A hole 17a (see FIG. 8) is formed on the upper end center of the shaft 17, and the shaft 17 is attached to the handle 20 to be able to rotate with the central axis as the center by a pin 26 described later (see FIG. 9).

As shown in FIG. 1, the handle 20 is disk-shaped, more specifically, is configured in a corolla shape having a certain degree of thickness, and can be operated using one hand. The bottom surface center part of the handle 20 bulges downward (see FIG. 5). This bulging part is indicated by code 20a. With this bulging part 20a, when the stopper 29 described later contacts the outer surface of the body 11, a gap is created between the outer periphery part of the handle 20 and the outer surface of the body 11. The handle 20 is constituted from an upper half and a lower half, and has a structure in which the lower half is screwed into the upper half.

FIG. 9 is a perspective view of the pressurization device 10 showing the attachment structure of the shaft 17.

As shown in the drawing, a recess 27 is formed at the upper half center of the handle 20, a shaft part of the pin with a head 26 is inserted in a hole in the bottom center (not illustrated) of the recess 27, and is pressed into the hole 17a of the upper end center of the shaft 17 (see FIG. 8). It is also possible to attach the shaft 17 to the handle 20 using a tapping screw instead of the pin 26. The recess 27 of the upper half center of the handle 20 is covered by a cover.

FIG. 8 is a plan view showing the interior of the handle 20 of the pressurization device 10.

As shown in the drawing, the handle 20 is linked with the shaft 17 with a torque limiter (clutch) 21 interposed. The torque limiter 21 is constituted from a first engaging part 21a fixed to the shaft 17, and a star-shaped second engaging part 21b having an internal gear-shaped inner peripheral surface that is formed on the lower half of the handle 20 and that surrounds the first engaging part 21a. The first engaging part 21a is constituted by a base 210a externally fitted to the nut 25, and a belt-shaped part 211a that has elasticity, is linked at both ends, and that swells in an arc shape on the base 210a. Also, under normal conditions, a projection 212a of the belt-shaped part 211a engages with the valley part of the inner surface of the second engaging part 21b, and the power of the handle 20 is transmitted to the shaft 17 via the torque limiter 21. Meanwhile, when excess load acts on the handle 20, the projection 212a of the belt-shaped part 211a is in sliding contact so as to follow the inner surface of the engaging part 21b, and power transmission of the handle 20 is blocked by the elastic deformation of the belt-shaped part 211a accompanying that.

Furthermore, as shown in FIG. 4, the male thread part 18 is formed on the shaft 17 on the upper half between the handle 20 and the pressing part 19, and meanwhile, the lower half is a part where a male thread is not formed (cylindrical part) 18a. The diameter of the part where a male thread is not formed 18a is the same or slightly smaller than the diameter of the valley of the male thread part 18. Also, when the handle 20 is operated in the direction in which the pressing part 19 rises, and as shown in FIG. 6, if the top surface of the raised part 19a of the pressing part 19 contacts the screw cylinder 15, the part where a male thread is not formed 18a of the shaft 17 confronts the female thread part 16, and the handle 20 and the shaft 17 spin idly. In contrast to this, in a case when there is no part where a male thread is not formed 18a on the shaft 17, and the entirety has the male thread part 18, as long as the handle 20 turns, the shaft 17 rises due to screw feed, the pressing part 19 is pressed forcefully against the screw cylinder 15, and there is a risk that the tapping screw 30 that attaches the pressing part 19 to be able to spin idly on the shaft 17 will fall out.

Also, as shown in FIG. 7, the stopper 29 is provided on the shaft 17 on the part directly above the male thread part 18. The stopper 29 is a ring-shaped flange part of a shape that protrudes radially outward from the shaft 17. In a case such as when there is no molding die 50, the handle 20 is operated in the pressing part 19 lowering direction and the pressing part 19 is lowered excessively, and as shown in FIG. 7, when the handle 20 abuts the top surface of the raised part 11a, this stopper 29 works to stop rotation of the shaft 17.

This results in the torque limiter 21 operating. Though the handle 20 is capable of a rotation operation thereafter as well, even if the handle 20 is rotated, it spins idly with respect to the shaft 17 and its power is not transmitted to the shaft 17. In contrast to this, when there is no stopper 29, even if the bottom surface of the handle 20 abuts the top surface of the raised part 11a, the torque limiter 21 does not work, so as long as the handle 20 is turned, the shaft 17 rotates, and there is the risk of damage occurring to the handle 20 or the body 11 by the bottom surface of the handle 20 being forcefully pressed against the top surface of the raised part 11a. That possibility is particularly high when at least one of the handle 20 and the body 11 is made of plastic. With the pressurization device 10 of the embodiment, though not particularly limited, the handle 20 and the body 11 are made of plastic.

Attachment of the stopper 29 to the shaft 17 needs to be set at a position at which the molding die 50 which is the object to be pressurized is suitably pressed, or at a position at which the shaft 17 enters more deeply than that, at a location at which it will be abutted on the top surface of the body 11. However, when there is a margin between the position at which the molding die 50 which is the object to be pressurized is suitably pressurized and the floor surface, it is preferable to be set in a location where fingers will not be pinched by the floor surface and the pressing part 19.

It is also possible for the stopper 29 to not be fixed to the shaft 17, and can be provided to be able to spin idly around the axis of the shaft 17 if not moving in the axial direction of the shaft 17.

### Manufacturing Method for the Egg-Shaped Container 80

First, paper which is the raw material is packed into the hole 53 of the lower die 51. Next, water is placed in the hole 53 and blended well with the paper. It is also possible to moisten the paper from the start, and pack the paper into the hole 53 after that. Thereafter, the upper die 52 is placed on the lower die 51, and the molding die 50 is set in the setting section 14 of the pressurization device 10.

Next, the handle 20 is operated in the direction that lowers the pressing part 19. By doing this, as shown in FIG. 5, the pressing part 19 is lowered and presses the upper die 52 of the molding die 50 downward, pressing the upper die 52 against the lower die 51. The pressing force increases as the handle 20 is turned, but when a prescribed value is exceeded, the pressing part 19 is forcefully pressed against the shaft 17, so rotation of the shaft 17 stops, the torque limiter 21 operates, and the power of the handle 20 is not transmitted to the shaft 17. Thereafter, the molding die 50 is removed from the setting section 14 of the pressurization device 10.

Water squeezed out of the paper is collected in the removed molding die 50, so that extra water is discarded, and the molded paper is removed from the molding die 50 and dried. This removal of the molded paper from the molding die 50 may also be done after the paper has dried to some degree. This completes the container half body 81 of the egg-shaped container 80.

Working as described above, the container half body 81 of the egg-shaped container 80 is created, then one more container half body 81 is created, and the two container half bodies 81 are decorated. Then, a small item such as a doll 82, etc., is placed in the container half body 81, the edges of the two container half bodies 81 are glued together, etc., and this is used as a small item container.

### Embodiment Modification Example

The present invention is not limited to the embodiment noted above, and it goes without saying that various modifications are possible without straying from the gist.

For example, with the embodiment noted above, a case was explained in which the molding die 50 was used to create the container half bodies 81 of the egg-shaped container 80, but it can also be applied when using another molding die to produce dolls or flower shape items.

Furthermore, with the embodiment noted above, a case was explained of applying the pressurization device 10 to the molding device 100, but it is also possible to apply this broadly to badge manufacturing devices and other processing devices, etc.

Also, with the embodiment noted above, a case was explained of the shaft 17 operating in the vertical direction, but it is also possible to apply the invention of this application in cases of operating in a lateral direction or other direction.

### Effect of the Invention

With the first means, if the handle is rotated in one direction when there is no object to be pressurized in the setting section, for example, the handle approaches the outer surface of the body. In this case, first, the stopper contacts the outer surface of the body, and rotation of the shaft is blocked. Having done that, excess load acts on the handle, the torque limiter operates to make the handle spins idly with respect to the shaft, and abutting of the handle on the body is blocked. This makes it possible to prevent sliding contact between the handle and the body.

With the second means, the stopper is a ring-shaped flange part that protrudes radially outward from the outer circumference of the shaft, so the strength of the stopper increases, and the entire circumference of the shaft abuts the outer surface of the body, making it possible to reliably block lowering of the shaft.

With the third means and the fourth means, when lowering of the shaft is stopped, it is possible to create a gap between the outer periphery part of the handle and the outer surface of the body, and possible to prevent fingers from being forcefully pinched.

What is claimed is:

1. A pressurization device, comprising:
a body including a setting section and an insertion section, the setting section being configured to accommodate an object to be pressurized, the insertion section including a female thread part formed on a hole wall thereof;
a shaft having a first longitudinal end and a second longitudinal end being opposite to the first longitudinal end, the first longitudinal end being inserted in the setting section, the second longitudinal end being at outside of the body, the shaft having a male thread part being engaged with the female thread part, the shaft being configured to advance and retreat with respect to the setting section by rotation with a central axis as the center,
a stopper being configured on the shaft;
a pressing part being configured on the first longitudinal end to press the object in the setting section against a prescribed fixed part when the shaft advances, and
a handle being configured on the second longitudinal end to rotate the shaft, wherein
the handle including a torque limiter is being configured to block transmission of power between the handle and the shaft when the power exceeds a prescribed amount,
when the female thread part is engaged with the male thread part and when the shaft enters deeper than a prescribed position, the stopper being configured to abut an outer surface of the body and to block the handle from abutting the outer surface of the body.

2. The pressurization device according to claim 1, wherein
the stopper is a ring-shaped flange part protruding radially outward from an outer circumference of the shaft.

3. The pressurization device according to claim 1, wherein
the handle has a disk shape of which a center matches with a center of the shaft,
a part, which surround the shaft, of an outer surface of the body is raised toward an outside of the body, and
the part abuts the stopper.

4. The pressurization device according to claim 3, wherein
a center part of the handle bulges facing the body.
